(19) United States
(12) Patent Application Publication
(10) Pub. No.: US 2010/0140441 A1
(43) Pub. Date: Jun. 10, 2010

(54) METHOD FOR REDUCING VIBRATIONS FROM A MOTOR VEHICLE EXHAUST SYSTEM

(75) Inventors: Christophe Chervin, Neydens (FR); Orvar E. Otterstedt, Cartigny (CH); Mark S. Jacobson, Solon, OH (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilimington, DE (US)

(21) Appl. No.: 12/631,093

(22) Filed: Dec. 4, 2009

Related U.S. Application Data
(60) Provisional application No. 61/201,054, filed on Dec. 5, 2008.

(51) Int. Cl. F16M 13/00; B29B 13/00; B29C 47/08

(52) U.S. Cl. 248/610; 264/148; 264/271.1

(57) ABSTRACT

Methods for reducing vibration or noise from the exhaust system of a motor vehicle, especially of an automobile, by producing a thermoplastic vulcanizate muffler hanger and mounting it between the exhaust system and the body of the motor vehicle. Also, the thermoplastic vulcanizate muffler hangers so produced.

### FIELD OF INVENTION

The recited invention relates to methods for reducing vibration from a motor vehicle exhaust system, wherein, in particular a muffler, also known as silencer, is installed using an extruded thermoplastic vulcanizate muffler hanger.

### BACKGROUND OF THE INVENTION

Vibration and noise absorbers and/or isolators are widely used in the vehicle and machine industries, particularly to protect machines from the side effects of vibrations. Rubber is widely used in shock absorbers, vibration dampers or absorbers, noise dampers, and flexible joints as a coupling element between rigid structures. Notably, rubber is used in the hanging systems for mufflers and/or exhaust pipes for reducing the amplitude of exhaust pipe vibrations that may cause noise, transmission of vibrations into the vehicle and shearing of the pipe and neighboring mechanical elements. Because such hanging systems are exposed to exhaust gases, extreme temperature variations and chemical pollution, they require oil and/or heat resistance, are therefore usually made of nitrile-butadiene rubber (NBR) and produced by injection molding, followed by curing.

Injection molding is a conventional technique for manufacturing plastic parts, in which molten plastic is injected at a high pressure into a mold having the shape of interest. Using injection molding, rubber is injected to the desired shape and subsequently crosslinked, that is, cured, in situ in the mold at high temperature. Curing conditions, e.g., time, temperature, depend on the nature of the rubber and can take extra energy, which adds to production costs. The productivity of using injection molding for rubber is measured by number of parts per hour and is limited by the curing conditions and extra curing energy. The productivity of such a production mode for muffler hangers is typically around 500 parts per hour.

Current methods for reducing vibrations and/or noise of exhaust pipes, especially muffler hangers, and which use rubber take several steps that are time consuming and hamper high productivity. In addition, thermoset rubber is not recyclable and therefore not optimal in terms of environmental protection.

There remains a need to develop alternative methods for reducing vibrations and/or noise of exhaust pipes.

### SUMMARY

Described herein are methods for reducing vibration from the exhaust system such as a pipe of a motor vehicle, especially an automobile, truck, boat, tractor or airplane, which comprise:

(1) extruding a thermoplastic vulcanizate polymer through a die having the shape of a muffler hanger;
(2) slicing the extruded thermoplastic vulcanizate polymer to yield a muffler hanger of the desired thickness; and
(3) mounting the muffler hanger between the exhaust system and the body of the vehicle, wherein the thermoplastic vulcanizate polymer is selected from the group consisting of:
I) a TPV comprising:
(A) from at or about 15 to or about 60 wt-% of a polyalkylene phthalate polyester polymer or copolymer continuous phase, and
(B) from at or about 40 to or about 85 wt-% of a polyethylene/(meth)acrylate rubber dispersed phase,
   wherein:
   the weight percentages are based on the total weight of the thermoplastic vulcanizate polymer, and
   the rubber is dynamically cross-linked with a peroxide free radical initiator and an organic diene co-agent;
   (II) a TPV comprising:
(A) from at or about 25 to or about 60% wt-% of a polyamide resin, and
(B) from at or about 75 to 40% wt-% of a rubber component;
   wherein:
   the weight percentages are based on the total weight of the thermoplastic vulcanizate polymer,
   the rubber component comprises
from at or about 20 to or about 80 wt-% of a hydrogenated nitrile group containing rubber and
from at or about 80 to or about 20 wt-% of an acrylic rubber and
   is dispersed in the form of cross-linked particles in said polyamide resin,
   the hydrogenated nitrile group containing rubber is
a hydrogenated copolymer comprising
   from at or about 10 to or about 60 wt-% of a vinyl nitrile,
   from at or about 15 to or about 90 wt-% of a conjugated diene and
   from at or about 0 to or about 75 wt-% of a monomer copolymerizable with vinyl nitrile and the conjugated diene, and
has an iodine value of 120 or less,
   the acrylic rubber is
a copolymer of at least one acrylate selected from the group consisting of
   an alkyl acetate and an alkoxy-substituted alkyl acrylate
      with at least one compound selected from the group consisting of
         a nonconjugated diene, a conjugated diene, a dihydrodicyclopentadienyl group containing (meth)acrylate, an epoxy group containing ethylenically unsaturated compound, an active halogen containing ethylenically unsaturated compound and a carboxyl group containing ethylenically unsaturated compound;
            (III) a TPV made by a method comprising:

(I) mixing:
(A) a rheologically-stable polyamide resin having
   a melting point or glass transition temperature at or about 25° C. to about 275° C.,
(B) a silicone base comprising:
   (B′) 100 parts by weight of a diorganopolysiloxane gum having a plasticity of at least 30 and having an average of at least 2 alkenyl groups in its molecule, and
   (B″) 5 to 200 parts by weight of a reinforcing filler, the weight ratio of the silicone base to the polyamide resin being greater than 35:65 to 85:15,
(C) for each 100 parts by weight of said polyamide resin, a compatibilizer selected from:
   (i) from 0.1 to 5 parts by weight of a coupling agent
      having a molecular weight of less than 800 and
      containing at least two groups
         independently selected from an ethylenically unsaturated group, epoxy, anhydride, silanol, carboxyl, hydroxyl and alkoxy,
         having 1 to 20 carbon atoms or oxazoline in its molecule,
   (ii) from 0.1 to 10 parts by weight of a functional diorganopolysiloxane having
      at least one group selected from
         epoxy, anhydride, silanol, carboxyl, amine and alkoxy,
         having 1 to 20 carbon atoms or oxazoline in its molecule, and
   (iii) from 0.1 to 10 parts by weight of a copolymer comprising
      at least one diorganopolysiloxane block and at least one block selected from
         polyamide, polyether, polyurethane, polyurea, polycarbonate and polyacrylate,
(D) an organohydrido silicon compound comprising
   an average of at least 2 silicon-bonded hydrogen groups in its molecule, and
(E) a hydrosilation catalyst,
   wherein components (D) and (E) are present in an amount sufficient to cure the diorganopolysiloxane (B′); and

(II) dynamically curing the diorganopolysiloxane (B′);

(IV) a TPV made by a method comprising:

(i) mixing:
(A) a thermoplastic resin comprising
more than 50 percent by volume of a polyester resin and
having a softening point at or about 23° C. to or about 300° C.,
(B) a silicone elastomer comprising:
   (E′) 100 parts by weight of a diorganopolysiloxane gum having
   a plasticity of at least 30 and
   an average of at least 2 alkenyl groups in its molecule and, optionally,
   (E″) up to 200 parts by weight of a reinforcing filler, the weight ratio of said silicone elastomer to said thermoplastic resin is from 35:65 to 85:15,
(C) a glycidyl ester compatibilizer,
(D) an organohydrido silicone compound containing an average of at least 2 silicon-bonded hydrogen groups in its molecule, and
(E) a hydrosilation catalyst,
   wherein components (D) and (E) are present in an amount sufficient to cure said diorganopolysiloxane (B′), and

(ii) dynamically vulcanizing said diorganopolysiloxane (E′);

(V) a TPV comprising:
(A) from at or about 20 to or about 70 wt-% of a mixture (M) of two or more polyalkylene phthalates,
(B) from at or about 2 to or about 60 wt-% of a cross-linked acrylate rubber,
(C) from at or about 0.5 to or about 20 wt-% of an ionomer, and
(D) from at or about 1 to or about 30 wt-% of a terpolymer of ethylene, butylacrylate (BA) and glycidylmethacrylate (GMA),
   wherein the weight percentages are based on the sum of (A), (B), (C) and (D);
   (VI) a TPV comprising:
(A) from or about 20 to or about 80 wt-% of a mixture (M) of two or more polyalkylene phthalates,
(B) from or about 2 to or about 60 wt-% of a cross-linked acrylate rubber,
(C) from or about 0 to or about 20 wt-% of an ionomer, and
(D) from or about 0 to or about 30 wt-% of a terpolymer of ethylene, butylacrylate (BA) and glycidylmethacrylate (GMA),
   wherein the weight percentages are based on the sum of (A), (B), (C) and (D); and
   (VII) mixtures of TPVs (I) to (VI).

Also described herein are extruded thermoplastic vulcanizate muffler hangers.

### BRIEF DESCRIPTION OF DRAWINGS

FIG. 1 A-D shows various shapes of muffler hangers that may be used in the method of the invention.

FIG. 2 shows mounting a muffler hanger to a car in the methods described herein.

### DETAILED DESCRIPTION

### Abbreviations

The following abbreviations are to be used to signify terms disclosed in the specification and recited in the claims:

“TPV” signifies thermoplastic vulcanizate.

“wt-%” signifies weight percent.

### DEFINITIONS

The following definitions are to be used in interpreting the meaning of terms disclosed in the specification and recited in the claims.

As used herein, the term “muffler” or “silencer” refers to a device designed to muffle noise generated from an engine, especially from an automobile. Typically, a muffler is centrally-mounted along the exhaust pipe installed in the longitudinal direction of a motor vehicle for primarily discharging exhaust gas from an engine toward the rear of the motor vehicle. Mufflers are subjected to high and low frequency vibrations, corrosive gas emission and high temperatures.

As used herein, the term “muffler hanger” or “muffler mount” or “silencer supporting device” refers to any device for attaching the exhaust system to the body of the motor vehicle and which is designed to reduce the vibration and/or the noise of the muffler transferred from the exhaust pipe or to reduce the vibration and/or the noise of the exhaust pipe itself. This term also refers to hanger devices for mufflers and/or exhaust pipes.

The muffler hanger is mounted between the exhaust system and the body of the motor vehicle, by passing a bolt, rivet or other fastening means through a hole in the centre of the muffler hanger, which bolt or rivet is secured to the undercarriage of the motor vehicle. The muffler hanger thus is interposed between the exhaust system and the undercarriage.

As used herein, the term “damping material” refers to material or articles that can dissipate energy in a system under cyclic stress. Such material can protect a variety of industrial items, including engines, machinery and equipment components. Particularly relevant, damping materials can absorb, decrease, or avoid (i) variation in the amplitude of oscillations or movements or vibrations; (ii) the intensity of sounds or vibrations; and (iii) the rebound of mobile parts that may lead to exhaust pipe shearing.

As used herein, the term “thermoplastic polymers” refers to polymers that can be re-melted and remolded under the influence of temperature without involving any important changes in properties.

As used herein, the term “thermoplastic vulcanizate” refers to blends of polymers comprising a continuous thermoplastic phase (e.g. polyalkylene like polypropylene and/or polyethylene polymers or copolymers such as polyalkylene phthalate polyesters) with a vulcanized elastomer phase, that is, a rubber phase, dispersed within the continuous thermoplastic phase.

As used herein, the terms “rubber phase” and “thermoplastic phase” refer to the polymeric morphological phases present in the resulting thermoplastic elastomeric blends derived from mixing and dynamic cross-linking of the cross-linkable rubber and the thermoplastic starting material.

Examples of rubber phase are polyacrylates vulcanizate rubber in combination with an effective amount of an agent (“co-agent”) able to cross-link the rubber during extrusion or injection molding. Examples of polyacrylates are poly(meth)acrylate or polyethylene/(meth)acrylate. As used herein, the term “acrylate” refers to an ester of acrylic acid with an alkyl group.

As used herein, the term “(meth)acrylic acid” refers to methacrylic acid and/or acrylic acid, inclusively. Likewise, the terms “(meth)acrylate” refers to methacrylate and/or acrylate and “poly(meth)acrylate” refers to polymers derived from the polymerization of either or a mixture of both corresponding type of monomers. Preferred in the invention are acrylates with alkyl groups having from 1 to 4 carbon atoms.

### Methods of Reducing Vibration in the Exhaust System of a Motor Vehicle

Described herein are methods of reducing vibration in the exhaust system, muffler or exhaust pipe of a motor vehicle, especially of an automobile, which rely on making a muffler hanger by extruding a thermoplastic vulcanizate polymer through a die having the shape of a muffler hanger, slicing the extrudate to produce a muffler hanger of desired thickness; and mounting the muffler hanger between the exhaust system and the body of the vehicle.

These methods combine the advantage of using extrusion to make muffler hangers, which reduces production cost and increases productivity, with the benefit of producing muffler hangers having desirable high oil and/or heat resistance properties. Moreover, by not being limited by the thickness of the extruded article, these methods can produce muffler hangers of varying shapes. In addition, muffler hangers made by these methods are recyclable and, consequently, environmentally friendly.

Thermoplastic Vulcanizates Suitable for Extrusion in the Methods Described Herein

The rubber in injection molded, muffler hangers may be replaced by thermoplastic vulcanizates (TPVs), a special class of thermoplastic elastomers (TPEs) made of a rubber/plastic polymer mixture with a highly vulcanized rubber phase. TPVs are typically made by mixing a thermoplastic component with a vulcanizable elastomer component under shear at a temperature above the melting point of the thermoplastic component, in the presence of a cross-linking agent that vulcanizes the elastomer component. The rubber is thus cross-linked and dispersed within the thermoplastic matrix at the same time. TPVs combine many desirable characteristics of cross-linked rubbers with some characteristics of thermoplastic elastomers.

Conventional TPV materials have a polypropylene (PP) thermoplastic phase and a fully cross-linked EPDM (ethylene-propylene-diene monomer) soft phase. A new class of TPVs also called “super-TPVs” or “thermoplastic silicone vulcanizates” (TPSiVs) consists of a cross-linked silicone rubber embedded in a nylon or thermoplastic polyurethane (TPU) matrix. Another new class of TPVs consists of a PP matrix incorporating a styrenic elastomer as the vulcanized rubber segment. Another emerging class of TPVs called “engineering TPV” (ETPV) combine a co-polyetherester matrix material with a highly cross-linked rubber as the vulcanized segment.

TPVs suitable in the methods described herein have oil, chemical and heat resistance. Typically, TPVs having a Shore A hardness from about 60 up to about 95 are suitable in these methods, preferably of about 80 up to about 95 Shore A hardness and more preferably of about 90 up to 95 Shore A hardness. TPVs having a good resistance at temperatures above 150° C. are preferred.

TPVs typically suitable for extruding techniques include those disclosed in Intl. Pat. App. Pub. No. WO 2004/029155, U.S. Pat. No. 6,362,287 (polyamide resin combined with a silicon base), U.S. Pat. No. 4,996,264 (polyamide resin combined with a rubber component composed of a nitrile group containing cross-linked rubber and an acrylic rubber), U.S. Pat. Nos. 6,774,162, and 6,569,985 and Int'l Pat. App. No. PCT/US06/12396, particularly in their Examples. A TPV disclosed in Int'l Pat. App. Pub. No. WO 2004/029155 is a curable thermoplastic blend comprising a polyalkylene phthalate polyester polymer or copolymer and a cross-linkable poly(meth)acrylate or polyethylene/(meth)acrylate vulcanizate rubber in combination with an effective amount of peroxide free-radical initiator and an organic diene co-agent to cross-link the rubber during extrusion or injection molding of the curable thermoplastic elastomeric blend. Therein, organic diene co-agent refers to organic co-agents that contain two or more unsaturated double bonds.

Other suitable TPVs include:

TPVs based on polypropylene (PP) and ethylene-propylene-diene copolymer (EPDM) and such as for example TFLEX™; Sarlink® by DSM, or Santoprene® by Advanced Elastomer Systems;

TPVs based on polypropylene and solution styrene butadienes (S-SBR) such as for example SEREL™ by Goodyear;

TPVs based on polypropylene and hydrogenated styrene-butadiene block copolymer (H-SBC) such as for example Uniprene® by Teknor-Apex;

TPVs based on copolyester (COPE) and ethylene-acrylate or ethylene acrylic elastomer (AEM) such as for example ETPV™ from DuPont; examples of ETPV from DuPont suitable in the context of the invention are ETPV 60A01L, ETPV 60A01L NC010, ETPV 60A01HSL BK001, ETPV 80A01L, ETPV 80A01NC010, ETPV 90A01L, ETPV 90A01NC010 and ETPV 90A01 HS BK 001;

TPVs based on polypropylene, polyamide, polyester and polyacrylate rubber such as for example Zeotherm® by Zeon;

TPVs based on polyamide, thermoplastic polyurethane (TPU), polyester and silicone such as for example TiPSiV by Dow Corning;

Commercially available TPV materials, which include Excelink™ by JSR; Forprene® by Polyone; NexPrene™ by Solvay Engineered Polymers; Milastomer® by Mitsui Chemicals; and Multiorene™ by Multibase.

The methods described herein can also extrude one of the six TPVs below as well as mixtures of these:

(1) A TPV comprising:
(A) from at or about 15 to or about 60 wt-% of a polyalkylene phthalate polyester polymer or copolymer continuous phase; and
(B) from at or about 40 to or about 85 wt-% of a polyethylene/(meth)acrylate rubber dispersed phase, wherein the rubber is dynamically cross-linked with a peroxide free radical initiator and an organic diene co-agent; the weight percentages being based on the total weight of the thermoplastic vulcanizate polymer;
   (2) A TPV comprising:
(A) from at or about 25 to or about 60 wt-% of a polyamide resin; and
(B) from at or about 75 to or about 40 wt-% of a rubber component;
   the weight percentages being based on the total weight of the thermoplastic vulcanizate polymer;
      wherein
      the rubber component comprises
from at or about 20 to or about 80 wt-% of a hydrogenated nitrile group containing rubber and
from at or about 80 to or about 20 wt-% of an acrylic rubber, and
   is dispersed in the form of cross-linked particles in said polyamide resin,
   the hydrogenated nitrile group containing rubber is
a hydrogenated copolymer comprising
   from at or about 10 to or about 60 wt-% of a vinyl nitrile,
   from at or about 15 to or about 90 wt-% of a conjugated diene and
   from at or about 0 to or about 75 wt-% of a monomer copolymerizable with vinyl nitrile and the conjugated diene, and
      has an iodine value of 120 or less;
      the acrylic rubber is
a copolymer of at least one acrylate selected from the group consisting of
   an alkyl acetate and an alkoxy-substituted alkyl acrylate
      with at least one compound selected from the group consisting of
         a nonconjugated diene, a conjugated diene, a dihydrodicyclopentadienyl group-containing (meth)acrylate, an epoxy group containing ethylenically unsaturated compound, an active halogen containing ethylenically unsaturated compound and a carboxyl group containing ethylenically unsaturated compound;
            (3) A TPV made by a method comprising:

(I) mixing:
(A) a rheologically-stable polyamide resin having
   a melting point or glass transition temperature at or about 25° C. to about 275° C.,
(B) a silicone base comprising:
   (B′) 100 parts by weight of a diorganopolysiloxane gum having a plasticity of at least 30 and having an average of at least 2 alkenyl groups in its molecule, and
   (B″) 5 to 200 parts by weight of a reinforcing filler, the weight ratio of the silicone base to the polyamide resin being greater than 35:65 to 85:15,
(C) for each 100 parts by weight of said polyamide resin, a compatibilizer selected from:
   (i) from 0.1 to 5 parts by weight of a coupling agent
      having a molecular weight of less than 800 and
      containing at least two groups
         independently selected from an ethylenically unsaturated group, epoxy, anhydride, silanol, carboxyl, hydroxyl and alkoxy,
         having 1 to 20 carbon atoms or oxazoline in its molecule,
   (ii) from 0.1 to 10 parts by weight of a functional diorganopolysiloxane having
      at least one group selected from
         epoxy, anhydride, silanol, carboxyl, amine and alkoxy,
         having 1 to 20 carbon atoms or oxazoline in its molecule, and
   (iii) from 0.1 to 10 parts by weight of a copolymer comprising
      at least one diorganopolysiloxane block and at least one block selected from
         polyamide, polyether, polyurethane, polyurea, polycarbonate and polyacrylate,
(D) an organohydrido silicon compound comprising
   an average of at least 2 silicon-bonded hydrogen groups in its molecule, and
(E) a hydrosilation catalyst,
   wherein components (D) and (E) are present in an amount sufficient to cure the diorganopolysiloxane (B′); and

(II) dynamically curing the diorganopolysiloxane (B′);

(4) A TPV made by a method comprising:

(I) mixing:
(A) a thermoplastic resin comprising
   more than 50 percent by volume of a polyester resin,
      wherein the thermoplastic resin has a softening point at or about 23° C. to or about 300° C.;
(B) a silicone elastomer comprising:
   (B′) 100 parts by weight of a diorganopolysiloxane gum
      having a plasticity of at least 30 and
      an average of at least 2 alkenyl groups in its molecule
         and, optionally,
   (B″) up to 200 parts by weight of a reinforcing filler,
      wherein the weight ratio of the silicone elastomer to the thermoplastic resin is from 35:65 to 85:15,
(C) a glycidyl ester compatibilizer,
(D) an organohydrido silicon compound comprising
   an average of at least 2 silicon-bonded hydrogen groups in its molecule, and
(E) a hydrosilation catalyst;
   wherein components (D) and (E) are present in an amount sufficient to cure said diorganopolysiloxane (B′); and

(II) dynamically vulcanizing said diorganopolysiloxane (B′);

(5) A TPV comprising:
(A) from at or about 20 to or about 70 wt-% of a mixture (M) of two or more polyalkylene phthalates,
(B) from at or about 2 to or about 60 wt-% of a cross-linked acrylate rubber,
(C) from at or about 0.5 to or about 20 wt-% of an ionomer, and
(D) from at or about 1 to or about 30 wt-% of a terpolymer of ethylene, butylacrylate (BA) and glycidylmethacrylate (GMA),
   wherein the weight percentages are based on the sum of (A), (B), (C) and (D);
   (6) A TPV comprising:
(A) from or about 20 to or about 80 wt-% of a mixture (M) of two or more polyalkylene phthalates,
(B) from or about 2 to or about 60 wt-% of a cross-linked acrylate rubber,
(C) from or about 0 to or about 20 wt % of an ionomer, and
(D) from or about 0 to or about 30 wt-% of a terpolymer of ethylene, butylacrylate (BA) and glycidylmethacrylate (GMA),
   wherein the weight percentages are based on the sum of (A), (B), (C) and (D)s; and
late (BA) and glycidylmethacrylate (GMA),
   wherein the weight percentages are based on the sum of (A), (B), (C) and (D); and
   (7) mixtures of TPVs (1) to (6).

Preferably, the thermoplastic vulcanizate polymer in the methods described herein is a TPV (1), i.e. a TPV comprising (A) from at or about 15 to or about 60 wt-% of a polyalkylene phthalate polyester polymer or copolymer continuous phase; and (B) from at or about 40 to or about 85 wt-% of a polyethylene/(meth)acrylate rubber dispersed phase, wherein the rubber is dynamically cross-linked with a peroxide free radical initiator and an organic diene co-agent and the weight percentages are based on the total weight of the thermoplastic vulcanizate polymer.

Suitable polyalkylene phthalate polyester polymers or copolymers include, but are not limited to, polyalkylene terephthalates (for example, poly(ethylene terephthalate) (PET), poly(trimethylene terephthalate) (PTT), poly(1,4-butylene terephthalate) (PBT), poly(ethylene 2,6-naphthoate), and poly(1,4-cyclohexyldimethylene terephthalate) (PCT)), polyalkylene terephthalate copolymers, and block copolyester elastomers, such as copolyetherester elastomers or copolyesterester elastomers.

Suitable peroxide free-radical initiators preferably decompose rapidly at the temperature of dynamic cross-linking. Examples include 2,5-dimethyl-2,5-di-(t-butylperoxy)-3-hexyne; t-butyl peroxybenzoate; 2,5-dimethyl-2,5-di-(t-butylperoxy)-2,5-dimethylhexane; dicumyl peroxide; α,α-bis(t-butylperoxy)-2,5-dimethylhexane; and the like.

Suitable organic diene co-agents include, but are not limited to, diethyleneglycol diacrylate; diethyleneglycol dimethacrylate; N,N′-m-phenylene dimaleimide; triallylisocyanurate; trimethylolpropane trimethacrylate; tetraallyloxyethane; triallyl cyanurate; tetramethylene diacrylate; polyethylene glycol dimethacrylate; and the like.

It is particularly preferred when the TPV comprises a continuous thermoplastic phase consisting of a copolyetherester that is a block copolymer of segments of poly(butylene terephthalate) and segments of poly(tetramethylene glycol), and a dispersed rubber phase that is an ethylene/methylacrylate copolymer elastomer. This is subjected to dynamic cross-linking using 2,5-dimethyl 2,5-di-(t-butylperoxy) hexyne-3 or 2,5-dimethyl-2,5-di-(t-butylperoxy) hexane free-radical initiator and diethylene glycol dimethacrylate co-agent.

### Methods of Making an Extruded Muffler Hanger Comprising TPVs Described Herein

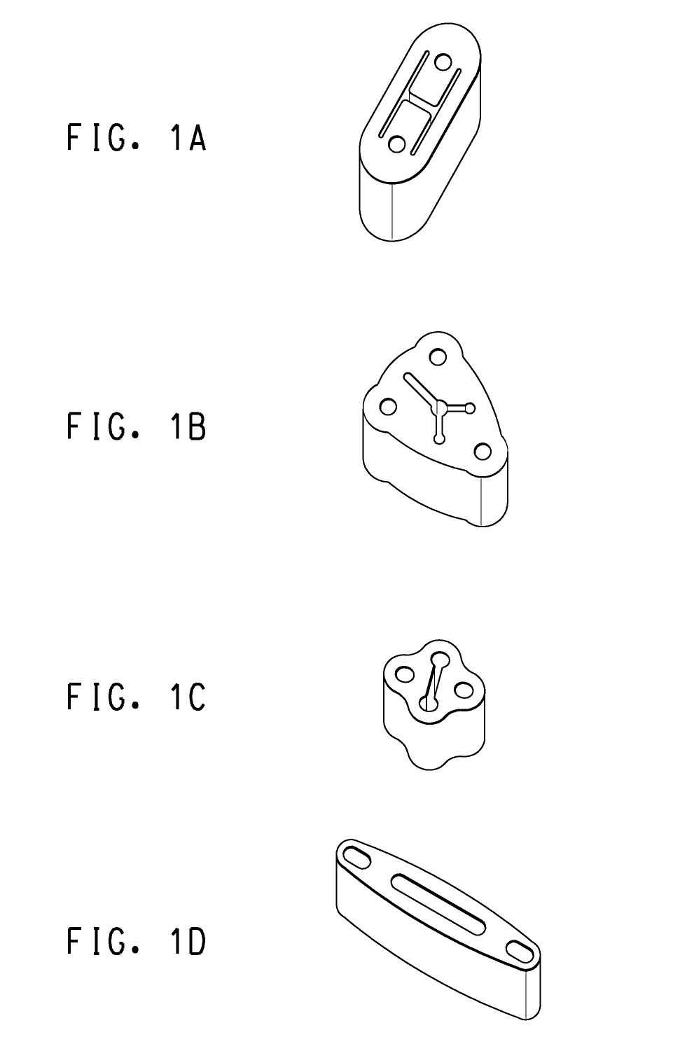

Muffler hangers made by the methods described herein may have any suitable shape to perform vibration and/or noise damping and include, for example, clamps, discs, brackets, annular members and cylindrical or oval bodies, so long as they are suitable shapes for extrusion. FIG. 1 A-D presents examples of the various shapes that a muffler hanger made by the methods described herein may take. Preferably, the muffler hanger takes the shape of a washer and preferably in the form of a flattened toroid that may be circular or elliptical. Square, rectangular, and irregular shapes are also suitable.

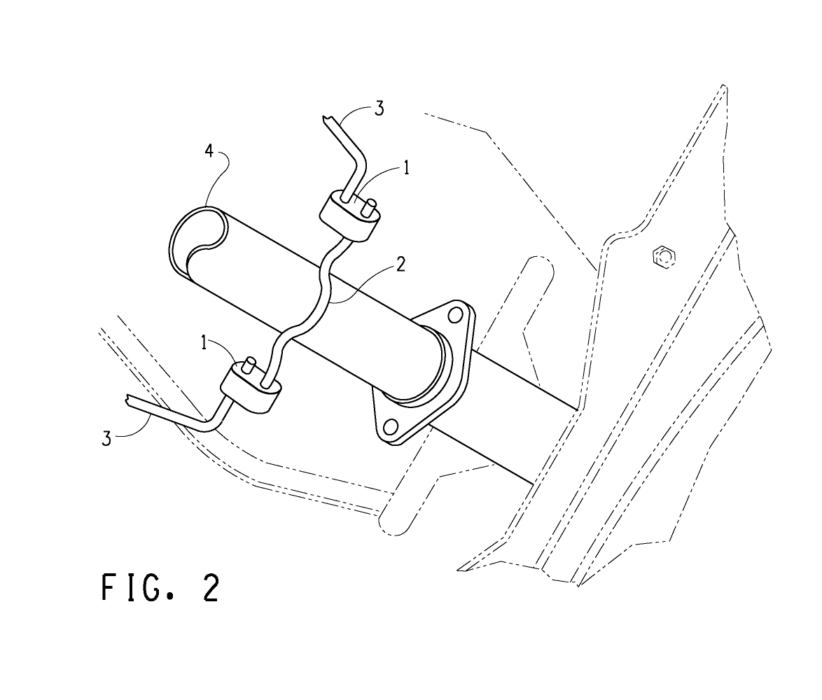

FIG. 2 illustrates how an extruded muffler hanger may attach an exhaust system to the undercarriage of an automobile in the method of the invention. The illustrated muffler hangers (1) have an elongated rounded trapezoidal form with a first hole at one end and a second hole at the other end. A metal rod (2) is held at either side of the exhaust pipe (4) by being inserted in the first holes of the muffler hangers (1). The rod (2) supports the exhaust pipe (4). Support rods (3) are attached to the car undercarriage at their one end, and inserted into the second holes in the muffler hangers (1) at the other end.

Usually, muffler hangers are used between the body of the motor vehicle and the muffler, but the muffler mount made by the methods described herein may be mounted so as to reduce vibration and/or noise of the exhaust pipe itself. U.S. Pat. Nos. 4,727,957 and 4,415,391 as well as JP2003278541 describe examples of muffler hangers.

Melt-extrusion of the TPV muffler hanger facilitates the processing of the muffler hanger as a thermoplastic article, while imparting to the muffler hanger properties of a cross-linked rubber article. In contrast to conventional vulcanizates thermosets, TPVs can be processed by extrusion, without further curing.

Preferably, the extruded thermoplastic vulcanizate muffler hanger is an extruded ETPV, automobile muffler hanger.

Described herein are methods of making thermoplastic vulcanizate muffler hangers that comprise the TPVs described in paragraphs 14 to 23 above. A preferred method both of making vulcanizate muffler hangers and of reducing vibration in the exhaust system, muffler or exhaust pipe of a motor vehicle occurs when the extrusion step of the thermoplastic vulcanizate polymer comprises the co-extrusion of a stiff material around the outer or inner circumference, preferably the outer circumference of the a muffler hanger. This preferred method increases the creep resistance of the obtained muffler hanger.

The stiff material can be a glass-reinforced thermoplastic polyester suitable for extrusion, such as glass reinforced polybutylene terephthalate (for example, Crastin® PBT) or poly(cyclohexylene-dimethylene) terephthalate (PCT) or polyamides such as aliphatic polyamides and/or semi-aromatic polyamides. Preferably, the stiff material is a glass reinforced polybutylene terephthalate. Should the adhesion between the thermoplastic vulcanizate polymer and the stiff material be insufficient, one or more tie-layers can be added between them.

To extrude a muffler hanger described herein, the TPV is processed in a hot moldable state through the gap between the pin and the die of an extrusion head and the extruded profile is cut to the desired thickness. The pin and the die are shaped to produce the desired cross-section of the article made by extrusion.

Typical extruders consist of two main components: a small heated drum and a die. Pre-heating of the material is optional, depending on the result desired. As the TPV enters the drum, it is softened through heating and then pressurized through the rotation of a screw. The pressure pushes the TPV through the die, located at the end of the extruder. The TPV then emerges from the extruder in a profile resembling the die shape, which for a typical muffler hanger, means asymmetrical shape, e.g. a flattened toroid, either elliptical or circular. The shape is extruded as profile, then cooled to room temperature by air blowing or water, or by water on a sizing table. The profile is then cut in line to the desired thickness of the final muffler hanger, i.e. approximately 25-30 mm.

The throughput of the methods described herein is of or about a minimum of about 1500 parts per hour. Thus, the methods described herein exhibit a 300 percent increase in productivity over the conventional methods of making muffler hangers of rubber that have to be cured.

The drying step—important for moisture-controlled conditions—before the cutting of the extrudate, is crucial. It is recommended that the drying step be carried out such that a dehumidifying drying unit directly and continuously feeds a suitable dehumidifying hopper or a sealer hopper.

Extruders suitable for use with common thermoplastics, such as nylon, PVC, or polyolefins, are usually suitable for the extrusion of thermoplastic vulcanizates. Length-to-diameter ratios of at least 20:1 and preferably 24:1 or higher are suitable for melt quality and good extrusion results. Preferably, the barrel is equipped with at least four heat-control zones and the temperature of each zone is controlled separately.

Typical extrusion screws suitable for thermoplastics can be used. Advantageous results can be obtained with simple 3-zones screws having different or approximately equal length, the 3-zones being a feed, a transition (compression) and a metering section. The length-to-diameter ratio should be a minimum of 20:1 and typically 24:1 or higher for good uniformity of the extrudate.

A typical melting temperature range for TPV extrusion is about 200° C. up to about 250° C. Specifically, for ETPV, a typical meting temperature range for extrusion is about 200° C. up to about 230° C.

When the muffler hangers are preferably made out of a TPV comprising:
(A) a copolyetherester that is a block copolymer of poly(butylene terephthalate) and poly(tetramethylene glycol) as continuous phase, and
(B) an ethylene/methylacrylate copolymer rubber dispersed phase, wherein the rubber is dynamically cross-linked with 2,5-dimethyl 2,5-di-(t-butylperoxy) hexyne-3 or 2,5-dimethyl-2,5-di-(t-butylperoxy) hexane free-radical initiator and diethylene glycol dimethacrylate co-agent,
   the TPV is extruded at a temperature at or about 230° C. through an extruder equipped with an extrusion head that will give the desired shape to the muffler hanger profile; the typical temperature profile for the extruder is 210° C. (hopper), 220° C. (barrel), 225° C. (barrel), 230° C. (barrel), and 230-225° C. (head).

Using a co-extrusion process, separate extruders are used to extrude each type of polymeric compositions. The temperature settings and other processing conditions for the extruders are arranged such that they are appropriate to the polymeric composition being extruded. This avoids having to expose lower-melting polymeric compositions to higher-than-normal processing temperatures during the extrusion step while allowing the extrusion of higher-melting polymeric compositions at a suitable temperature. The individual melts from the extrusion streams are combined together in a suitably designed die and arranged as desired.

What is claimed is:

1. A method for reducing vibration from an exhaust system of a motor vehicle, comprising:
extruding a thermoplastic vulcanizate polymer through a die having the shape of a muffler hanger;
slicing the extruded thermoplastic vulcanizate polymer to yield a muffler hanger of desired thickness; and
mounting the muffler hanger between the exhaust system and the body of the motor vehicle,
wherein the thermoplastic vulcanizate polymer is selected from the group consisting of:
I) a TPV comprising:
(A) from at or about 15 to or about 60 wt-% of a polyalkylene phthalate polyester polymer or copolymer continuous phase, and
(B) from at or about 40 to or about 85 wt-% of a polyethylene/(meth)acrylate rubber dispersed phase,
wherein:
the weight percentages are based on the total weight of the thermoplastic vulcanizate polymer, and
the rubber is dynamically cross-linked with a peroxide free radical initiator and an organic diene co-agent;
(II) a TPV comprising:
(A) from at or about 25 to or about 60% wt-% of a polyamide resin, and
(B) from at or about 75 to 40% wt-% of a rubber component;
wherein:
the weight percentages are based on the total weight of the thermoplastic vulcanizate polymer,
the rubber component comprises
from at or about 20 to or about 80 wt-% of a hydrogenated nitrile group containing rubber and
from at or about 80 to or about 20 wt-% of an acrylic rubber and
is dispersed in the form of cross-linked particles in said polyamide resin,
the hydrogenated nitrile group containing rubber is
a hydrogenated copolymer comprising
from at or about 10 to or about 60 wt-% of a vinyl nitrile,
from at or about 15 to or about 90 wt-% of a conjugated diene and
from at or about 0 to or about 75 wt-% of a monomer copolymerizable with vinyl nitrile and the conjugated diene, and
has an iodine value of 120 or less,
the acrylic rubber is
a copolymer of at least one acrylate selected from the group consisting of
an alkyl acetate and an alkoxy-substituted alkyl acrylate
with at least one compound selected from the group consisting of
a nonconjugated diene, a conjugated diene, a dihydrodicyclopentadienyl group containing (meth)acrylate, an epoxy group containing ethylenically unsaturated compound, an active halogen containing ethylenically unsaturated compound and a carboxyl group containing ethylenically unsaturated compound;
(III) a TPV made by a method comprising:
(I) mixing:
(A) a rheologically-stable polyamide resin having
a melting point or glass transition temperature at or about 25° C. to about 275° C.,
(B) a silicone base comprising:
(B′) 100 parts by weight of a diorganopolysiloxane gum having a plasticity of at least 30 and having an average of at least 2 alkenyl groups in its molecule, and
(B″) 5 to 200 parts by weight of a reinforcing filler, the weight ratio of the silicone base to the polyamide resin being greater than 35:65 to 85:15,
(C) for each 100 parts by weight of said polyamide resin, a compatibilizer selected from:
(i) from 0.1 to 5 parts by weight of a coupling agent
having a molecular weight of less than 800 and
containing at least two groups
independently selected from an ethylenically unsaturated group, epoxy, anhydride, silanol, carboxyl, hydroxyl and alkoxy,
having 1 to 20 carbon atoms or oxazoline in its molecule,
(ii) from 0.1 to 10 parts by weight of a functional diorganopolysiloxane having
at least one group selected from
epoxy, anhydride, silanol, carboxyl, amine and alkoxy,
having 1 to 20 carbon atoms or oxazoline in its molecule, and
(iii) from 0.1 to 10 parts by weight of a copolymer comprising
at least one diorganopolysiloxane block and at least one block selected from
polyamide, polyether, polyurethane, polyurea, polycarbonate and polyacrylate,
(D) an organohydrido silicon compound comprising
an average of at least 2 silicon-bonded hydrogen groups in its molecule, and
(E) a hydrosilation catalyst,
wherein components (D) and (E) are present in an amount sufficient to cure the diorganopolysiloxane (B′); and
(II) dynamically curing the diorganopolysiloxane (B′);
(IV) a TPV made by a method comprising:
(i) mixing:
(A) a thermoplastic resin comprising
more than 50 percent by volume of a polyester resin and having a softening point at or about 23° C. to or about 300° C.,
(B) a silicone elastomer comprising:
(E′) 100 parts by weight of a diorganopolysiloxane gum having
a plasticity of at least 30 and
an average of at least 2 alkenyl groups in its molecule and, optionally,
(E″) up to 200 parts by weight of a reinforcing filler, the weight ratio of said silicone elastomer to said thermoplastic resin is from 35:65 to 85:15,
(C) a glycidyl ester compatibilizer,
(D) an organohydrido silicone compound containing an average of at least 2 silicon-bonded hydrogen groups in its molecule, and
(E) a hydrosilation catalyst,
wherein components (D) and (E) are present in an amount sufficient to cure said diorganopolysiloxane (B′), and
(ii) dynamically vulcanizing said diorganopolysiloxane (E′);
(V) a TPV comprising:
(A) from at or about 20 to or about 70 wt-% of a mixture (M) of two or more polyalkylene phthalates,
(B) from at or about 2 to or about 60 wt-% of a cross-linked acrylate rubber,
(C) from at or about 0.5 to or about 20 wt-% of an ionomer, and
(D) from at or about 1 to or about 30 wt-% of a terpolymer of ethylene, butylacrylate (BA) and glycidylmethacrylate (GMA),
wherein the weight percentages are based on the sum of (A), (B), (C) and (D);
(VI) a TPV comprising:
(A) from or about 20 to or about 80 wt-% of a mixture (M) of two or more polyalkylene phthalates,
(B) from or about 2 to or about 60 wt-% of a cross-linked acrylate rubber,
(C) from or about 0 to or about 20 wt-% of an ionomer, and
(D) from or about 0 to or about 30 wt-% of a terpolymer of ethylene, butylacrylate (BA) and glycidylmethacrylate (GMA),
wherein the weight percentages are based on the sum of (A), (B), (C) and (D); and
(VII) mixtures of TPVs (I) to (VI).

2. The method of claim 1, wherein the thermoplastic vulcanizate polymer comprises:
(A) from at or about 15 to or about 60 wt-% of a polyalkylene phthalate polyester polymer or copolymer continuous phase; and
(B) from at or about 40 to or about 85 wt-% of a polyethylene/(meth)acrylate rubber dispersed phase, wherein the rubber is dynamically cross-linked with a peroxide free radical initiator and an organic diene co-agent,
wherein the weight percentages are based on the total weight of the thermoplastic vulcanizate polymer.

3. The method of claim 1, wherein the extrusion comprises the co-extrusion of a stiff material around the shape of a muffler hanger.

4. The method of claim 2, wherein the extrusion comprises the co-extrusion of a stiff material around the shape of a muffler hanger.

5. The method according to claim 4 wherein the stiff material co-extruded around the shape of a muffler hanger is a glass reinforced thermoplastic polyester.

6. The method of claim 1, wherein the thermoplastic vulcanizate polymer consists of a continuous phase consisting of
a copolyetherester that is
a block copolymer of segments of poly(butylene terephthalate) and segments of poly(tetramethylene glycol), and
a dispersed rubber phase that is
an ethylene/methylacrylate copolymer elastomer
subjected to dynamic cross-linking using 2,5-dimethyl 2,5-di-(t-butylperoxy) hexyne-3 or 2,5-dimethyl-2,5-di-(t-butylperoxy) hexane free-radical initiator and diethylene glycol dimethacrylate co-agent.

7. An extruded thermoplastic vulcanizate muffler made by the method comprising the steps of:
extruding a thermoplastic vulcanizate polymer through a die having the shape of a muffler hanger;
slicing the extruded thermoplastic vulcanizate polymer to yield a muffler hanger of desired thickness; and
mounting the muffler hanger between the exhaust system and the body of the motor vehicle,
wherein the thermoplastic vulcanizate polymer is selected from the group consisting of:
I) a TPV comprising:
(A) from at or about 15 to or about 60 wt-% of a polyalkylene phthalate polyester polymer or copolymer continuous phase, and
(B) from at or about 40 to or about 85 wt-% of a polyethylene/(meth)acrylate rubber dispersed phase,
wherein:
the weight percentages are based on the total weight of the thermoplastic vulcanizate polymer, and
the rubber is dynamically cross-linked with a peroxide free radical initiator and an organic diene co-agent;
(II) a TPV comprising:
(A) from at or about 25 to or about 60% wt-% of a polyamide resin, and
(B) from at or about 75 to 40% wt-% of a rubber component;
wherein:
the weight percentages are based on the total weight of the thermoplastic vulcanizate polymer,
the rubber component comprises
from at or about 20 to or about 80 wt-% of a hydrogenated nitrile group containing rubber and
from at or about 80 to or about 20 wt-% of an acrylic rubber and
is dispersed in the form of cross-linked particles in said polyamide resin,
the hydrogenated nitrile group containing rubber is
a hydrogenated copolymer comprising
from at or about 10 to or about 60 wt-% of a vinyl nitrile,
from at or about 15 to or about 90 wt-% of a conjugated diene and
from at or about 0 to or about 75 wt-% of a monomer copolymerizable with vinyl nitrile and the conjugated diene, and
has an iodine value of 120 or less,
the acrylic rubber is
a copolymer of at least one acrylate selected from the group consisting of
an alkyl acetate and an alkoxy-substituted alkyl acrylate
with at least one compound selected from the group consisting of
a nonconjugated diene, a conjugated diene, a dihydrodicyclopentadienyl group containing (meth)acrylate, an epoxy group containing ethylenically unsaturated compound, an active halogen containing ethylenically unsaturated compound and a carboxyl group containing ethylenically unsaturated compound;
(III) a TPV made by a method comprising:
(I) mixing:
(A) a rheologically-stable polyamide resin having
a melting point or glass transition temperature at or about 25° C. to about 275° C.,
(B) a silicone base comprising:
(B′) 100 parts by weight of a diorganopolysiloxane gum having a plasticity of at least 30 and having an average of at least 2 alkenyl groups in its molecule, and
(B″) 5 to 200 parts by weight of a reinforcing filler, the weight ratio of the silicone base to the polyamide resin being greater than 35:65 to 85:15,
(C) for each 100 parts by weight of said polyamide resin, a compatibilizer selected from:
(i) from 0.1 to 5 parts by weight of a coupling agent
having a molecular weight of less than 800 and
containing at least two groups
independently selected from an ethylenically unsaturated group, epoxy, anhydride, silanol, carboxyl, hydroxyl and alkoxy,
having 1 to 20 carbon atoms or oxazoline in its molecule,
(ii) from 0.1 to 10 parts by weight of a functional diorganopolysiloxane having
at least one group selected from
epoxy, anhydride, silanol, carboxyl, amine and alkoxy,
having 1 to 20 carbon atoms or oxazoline in its molecule, and
(iii) from 0.1 to 10 parts by weight of a copolymer comprising
at least one diorganopolysiloxane block and at least one block selected from
polyamide, polyether, polyurethane, polyurea, polycarbonate and polyacrylate,
(D) an organohydrido silicon compound comprising
an average of at least 2 silicon-bonded hydrogen groups in its molecule, and
(E) a hydrosilation catalyst,
wherein components (D) and (E) are present in an amount sufficient to cure the diorganopolysiloxane (B′); and
(II) dynamically curing the diorganopolysiloxane (B′);
(IV) a TPV made by a method comprising:
(i) mixing:
(A) a thermoplastic resin comprising
more than 50 percent by volume of a polyester resin and
having a softening point at or about 23° C. to or about 300° C.,
(B) a silicone elastomer comprising:
(E′) 100 parts by weight of a diorganopolysiloxane gum having
a plasticity of at least 30 and
an average of at least 2 alkenyl groups in its molecule and, optionally,
(E″) up to 200 parts by weight of a reinforcing filler, the weight ratio of said silicone elastomer to said thermoplastic resin is from 35:65 to 85:15,
(C) a glycidyl ester compatibilizer,
(D) an organohydrido silicone compound containing an average of at least 2 silicon-bonded hydrogen groups in its molecule, and
(E) a hydrosilation catalyst,
wherein components (D) and (E) are present in an amount sufficient to cure said diorganopolysiloxane (B′), and
(ii) dynamically vulcanizing said diorganopolysiloxane (E′);
(V) a TPV comprising:
(A) from at or about 20 to or about 70 wt-% of a mixture (M) of two or more polyalkylene phthalates,
(B) from at or about 2 to or about 60 wt-% of a cross-linked acrylate rubber,
(C) from at or about 0.5 to or about 20 wt-% of an ionomer, and
(D) from at or about 1 to or about 30 wt-% of a terpolymer of ethylene, butylacrylate (BA) and glycidylmethacrylate (GMA),
wherein the weight percentages are based on the sum of (A), (B), (C) and (D);
(VI) a TPV comprising:
(A) from or about 20 to or about 80 wt-% of a mixture (M) of two or more polyalkylene phthalates,
(B) from or about 2 to or about 60 wt-% of a cross-linked acrylate rubber,
(C) from or about 0 to or about 20 wt-% of an ionomer, and
(D) from or about 0 to or about 30 wt-% of a terpolymer of ethylene, butylacrylate (BA) and glycidylmethacrylate (GMA),
wherein the weight percentages are based on the sum of (A), (B), (C) and (D); and
(VII) mixtures of TPVs (I) to (VI).

8. The extruded thermoplastic vulcanizate muffler hanger of claim 7, wherein the extrusion comprises the co-extrusion of a stiff material around the shape of a muffler hanger.

9. The extruded thermoplastic vulcanizate muffler hanger of claim 7, wherein the thermoplastic vulcanizate polymer comprises:
(A) from at or about 15 to or about 60 wt-% of a polyalkylene phthalate polyester polymer or copolymer continuous phase; and
(B) from at or about 40 to or about 85 wt-% of a polyethylene/(meth)acrylate rubber dispersed phase, wherein the rubber is dynamically cross-linked with a peroxide free radical initiator and an organic diene co-agent,
wherein the weight percentages are based on the total weight of the thermoplastic vulcanizate polymer.

10. The extruded thermoplastic vulcanizate muffler hanger of claim 9, wherein the extrusion comprises the co-extrusion of a stiff material around the shape of a muffler hanger.

11. The extruded thermoplastic vulcanizate muffler hanger of claim 7, which is an automobile muffler hanger.

12. The extruded thermoplastic vulcanizate muffler hanger of claim 7, wherein the muffler hanger comprises a co-extruded outer shell comprising a glass reinforced thermoplastic polyester.

13. The extruded thermoplastic vulcanizate muffler hanger of claim 8, wherein the muffler hanger comprises a co-extruded outer shell comprising a glass reinforced thermoplastic polyester.

14. The extruded thermoplastic vulcanizate muffler hanger of claim 9, wherein the muffler hanger comprises a co-extruded outer shell comprising a glass reinforced thermoplastic polyester.

15. The extruded thermoplastic vulcanizate muffler hanger of claim 10, wherein the muffler hanger comprises a co-extruded outer shell comprising a glass reinforced thermoplastic polyester.

16. The extruded thermoplastic vulcanizate muffler hanger of claim 11, wherein the muffler hanger comprises a co-extruded outer shell comprising a glass reinforced thermoplastic polyester.
